(19) United States
(12) Patent Application Publication
(10) Pub. No.: US 2024/0119884 A1
(43) Pub. Date: Apr. 11, 2024

(54) DISPLAY DEVICE AND DISPLAY CHARGING METHOD

(71) Applicant: TCL CHINA STAR OPTOELECTRONICS TECHNOLOGY CO., LTD., Shenzhen (CN)

(72) Inventors: Qian WANG, Shenzhen (CN); Yoongu KIM, Shenzhen (CN); Zhaoming LIANG, Shenzhen (CN); Xinyi KANG, Shenzhen (CN)

(21) Appl. No.: 18/084,790

(22) Filed: Dec. 20, 2022

(30) Foreign Application Priority Data
Oct. 11, 2022 (CN) 202211240729.7

(51) Int. Cl. G09G 3/20

(52) U.S. Cl. CPC G09G 3/2018; G09G 2310/08

(57) ABSTRACT

The application provides a display device and a display charging method. The display device includes a timing controller and a gate driving circuit. By increasing a voltage difference between the first potential and the second potential of a scan signal, a falling edge of the scan signal can be made more vertical, and by adjusting a phase of the scan signal in a timing at the same time, a pulse duration of the scan signal can be overlaid to a pulse duration of more data signals, so that the effective charging time of the data signals can be increased.

### CROSS-REFERENCE TO RELATED APPLICATION

This application claims priority to and the benefit of Chinese Patent Application No. 202211240729.7, filed on Oct. 11, 2022, the entire content of which is hereby incorporated by reference.

### TECHNICAL FIELD

The present application relates to the field of display technologies, and more particularly to a display device and a display charging method.

### BACKGROUND

In a display technology, a gate driving circuit is generally configured to output a scan signal for controlling a data signal to be written to a pixel. However, the scan signal has a gradual falling edge due to various reasons, and cannot approach or reach a vertical falling edge in an ideal state, which seriously reduces a charging time of the pixel.

### SUMMARY

Embodiments of the present application provide a display device and a display charging method to alleviate a technical problem that a gradual falling edge of a scan signal causes a reduction in a charging time.

In a first aspect, an embodiment of the present application provides a display device, including a timing controller for transmitting a clock signal, where the clock signal has a first potential and a second potential that are alternately continuous, the first potential being less than the second potential; and a gate driving circuit for outputting a scan signal based on the received clock signal, where the scan signal has a portion of the clock signal and is changed in order of the first potential, the second potential, and the first potential within a first predetermined time period; where the display device increases a voltage difference between the first potential and the second potential of the scan signal, and adjusts a phase of the scan signal to increase an effective charging time of a pixel corresponding to the scan signal.

In some embodiments, the timing controller changes the first potential of the clock signal and/or the second potential of the clock signal to increase the voltage difference between the first potential and the second potential of the clock signal.

In some embodiments, the timing controller maintains the second potential of the clock signal unchanged and reduces the first potential of the clock signal.

In some embodiments, the voltage difference in the display device is configured to be in a positive relationship with the amount of phase change of the clock signal.

In some embodiments, the timing controller shifts a phase of the clock signal backward and/or the phase of the gate driving circuit shifts a phase of the scan signal backward.

In some embodiments, the scan signal is configured to control an effective charging time of the data signal, where an end time of the effective charging time is earlier than or equal to a start time of an end edge of the data signal, and the end edge is a falling edge of a positive pulse or a rising edge of a negative pulse.

In some embodiments, at and before the start time of the end edge, the scan signal controls a thin film transistor in the pixel to be in an ON state to write a pulse amplitude of the data signal to the pixel.

In some embodiments, the display device further includes a first low potential line for transferring a first low potential signal, where the scan signal further has a portion of the first low potential signal before and after a first preset time period, respectively.

In some embodiments, the first low potential signal has a third potential greater than the first potential and less than the second potential; and the scan signal has the third potential in a second preset time period, where the second preset time period and the first preset time period are alternately continuous in time.

In a second aspect, another embodiment of the present application provides a display charging method, including: outputting, by a gate driving circuit, a scan signal according to a received clock signal, where the clock signal has a first potential and a second potential that are alternately continuous, the first potential being less than the second potential; configuring the scan signal to have a portion of the clock signal, where the scan signal is changed in the order of the first potential, the second potential, and the first potential within a first predetermined time period; and increasing, by a display device, a voltage difference between the first potential and the second potential of the scan signal, and adjusting a phase of the scan signal to increase an effective charging time of a pixel corresponding to the scan signal.

According to the display device and the display charging method provided in the embodiments of the present application, by increasing the voltage difference between the first potential and the second potential of the scan signal, the falling edge of the scan signal can approximate the vertical falling edge in the ideal state, and by adjusting the phase of the scan signal in a timing at the same time, the pulse duration of the scan signal can cover the pulse duration of more data signals, so that the effective charging time of the data signals can be increased.

### BRIEF DESCRIPTION OF THE DRAWINGS

Technical solutions and other beneficial effects of the present application are apparent below from detailed description of the embodiments of the present application in combination with the accompanying drawings.

FIG. 1 is a schematic structural diagram of a display device according to an embodiment of the present application.

FIG. 2 is a schematic structural diagram of a gate driving unit in a gate driving circuit shown in FIG. 1.

FIG. 3 is a timing diagram of the gate driving unit shown in FIG. 2.

FIG. 4 is a waveform diagram of a scan signal in the related art shown in FIG. 3.

FIG. 5 is a charging schematic diagram of an ideal state according to an embodiment of the present application.

FIG. 6 is a charging schematic diagram of the related art.

FIG. 7 is a waveform diagram of a scan signal according to an embodiment of the present application.

FIG. 8 is a charging schematic diagram under the control of the scan signal shown in FIG. 7.

FIG. 9 is a charging diagram under the condition that a phase of the clock signal CK (N) is shifted backward on the basis of FIG. 8.

FIG. 10 is a schematic diagram of a relationship between an effective charging time and an absolute value of a first potential according to an embodiment of the present application.

FIG. 11 is a schematic diagram of a charging time distribution based on the charging effect shown in FIG. 6.

FIG. 12 is a schematic diagram of a charging time distribution based on the charging effect shown in FIG. 9.

FIG. 13 is a schematic structural diagram of a pixel driving architecture according to an embodiment of the present application.

FIG. 14 is another schematic structural diagram of a pixel driving architecture according to an embodiment of the present application.

### EMBODIMENTS OF THE PRE SENT DISCLOSURE

Technical solutions in embodiments of the present application will be clearly and completely described below in conjunction with drawings in the embodiments of the present application. Obviously, the described embodiments are only a part of embodiments of the present application, rather than all the embodiments. Based on the embodiments in the present application, all other embodiments obtained by those skilled in the art without creative work fall within the protection scope of the present application.

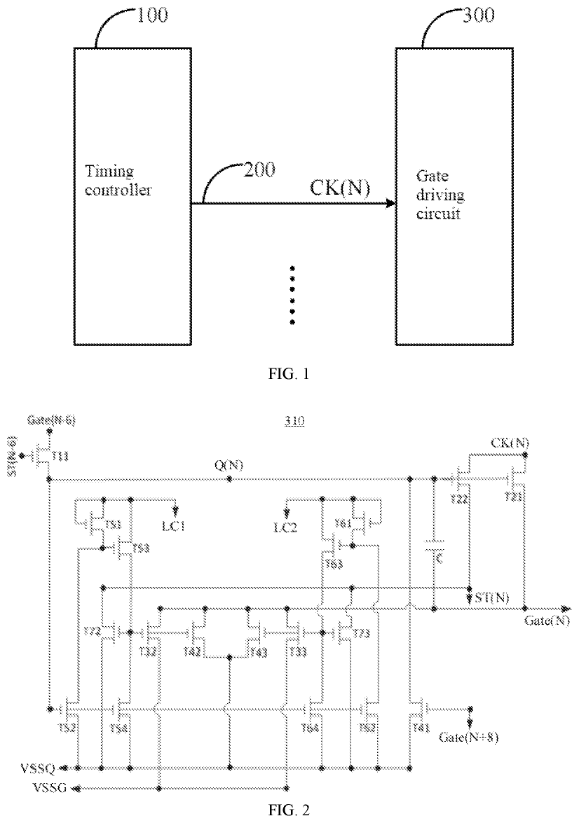

In view of the above-mentioned technical problem that the falling edge of the scan signal is relatively gradual, resulting in reduction in the charging time, an embodiment of the present application provides a display device. Referring to FIGS. 1 to 14, the display device includes a timing controller 100, a clock line 200, and a gate driving circuit 300, as shown in FIGS. 1, 3, 4, and 7. One end of the clock line 200 is connected to the timing controller 100, and the other end of the clock line 200 is connected to the gate driving circuit 300. The timing controller 100 is configured to transmit a clock signal CK(N). The clock line 200 is configured to transfer the clock signal CK(N). The gate driving circuit 300 may include a plurality of cascaded gate driving units 310, where each of the gate driving units 310 is configured to output a corresponding scan signal Gate(N) having a portion of the received clock signal CK(N) according to the clock signal CK(N). The clock signal CK(N) has a first potential V1 and a second potential V2 that are alternately continuous, and the first potential V1 is less than the second potential V2. The scan signal Gate(N) is changed in the order of the first potential V1, the second potential V2, and the first potential V1 in a first preset time period. The display device increases a pressure difference between the first potential and the second potential of the scan signal Gate(N), and adjusts the phase of the scan signal Gate(N) to increase an effective charging time of a pixel corresponding to the scan signal Gate(N).

It should be understood that, according to the display device provided in the embodiment of the present application, by increasing the voltage difference between the first potential and the second potential of the scan signal Gate(N), the falling edge of the scan signal Gate(N) can approximate the vertical falling edge in the ideal state, and by adjusting the phase of the scan signal Gate(N) in a timing at the same time, the pulse duration of the scan signal Gate(N) can be overlaid to the pulse duration of more data signals Data, so that the effective charging time of the data signals Data can be increased.

It should be noted that increasing the voltage difference between the first potential V1 and the second potential V2 of the scan signal Gate(N) by the display device may be realized by changing the first potential V1 of the clock signal CK(N) and/or the second potential V2 of the clock signal CK(N) by the timing controller 100. For example, the voltage difference of the scan signal Gate(N) may be increased by increasing the second potential V2 of the clock signal CK(N) while reducing the first potential V1. Alternatively, the voltage difference of the scan signal Gate(N) may be increased by maintaining the second potential V2 of the clock signal CK(N) unchanged while reducing the first potential V1. Alternatively, the voltage difference of the scan signal Gate(N) may be increased by increasing the second potential V2 of the clock signal CK(N) while maintaining the first potential V1 unchanged.

In one embodiment, the gate driving unit 310 includes a first transistor T21, where one of a source/drain of the first transistor T21 is connected to the clock line 200, a gate of the first transistor T21 is connected to a first node Q(N), and another one of the source/drain of the first transistor T21 is connected to the scan line; where, the scan line is configured to transfer the scan signal Gate(N).

It should be noted that, in the present embodiment, the first transistor T21 not only transmits the first potential V1 of the clock signal CK(N) as a portion of the scan signal Gate(N), but also transmits the second potential V2 of the clock signal CK(N) as a portion of the scan signal Gate(N), so that the voltage difference between the first potential V1 and the second potential V2 of the scan signal Gate(N) can be correspondingly changed by adjusting the voltage difference between the first potential and the second potential of the clock signal CK(N) so that the falling edge of the scan signal Gate(N) approximates a vertical configuration.

In one embodiment, the gate driving unit 310 further includes a second transistor T32, where one of a source/drain of the second transistor T32 is connected to the another one of the source/drain of the first transistor T21 and the scan line, another one of the source/drain of the second transistor T32 is connected to the first low potential line, and a gate of the second transistor T32 is connected to the second node. A potential of the first node Q(N) is one of a high potential or a low potential, and a potential of a second node is the other of the high potential or the low potential. A first low potential line is configured to transfer a first low potential signal VSSG, where a third potential V3 of the first low potential signal VSSG is greater than the first potential V1 and less than the second potential V2. The scan signal Gate(N) has the third potential V3 of the first low potential signal VSSG, the first potential V1, the second potential V2, the first potential V1, and the third potential V3 of the first low potential signal VSSG in timing that are continuous in sequence.

It should be noted that, in the present embodiment, the third potential V3 of the first low potential signal VSSG can be provided by the second transistor T32 as a portion of the scan signal Gate(N). The third potential V3 of the first low potential signal VSSG in the scan signal Gate(N) may all be provided by the second transistor T32 to save the number of transistors used in the gate driving circuit 300. It may also be provided in part by the second transistor T32 to reduce an operating time of the second transistor T32, thereby extending the service life of the second transistor T32.

In one embodiment, the gate driving unit 310 further includes a third transistor T33, where one of a source/drain of the third transistor T33 is connected to the another one of the source/drain of the first transistor T21, the scan line, and the one of the source/drain of the second transistor T32, another one of the source/drain of the third transistor T33 is connected to the first low potential line, and a gate of the third transistor T33 is connected to a third node. The third transistor T33 and the second transistor T32 are turned on in a timing division manner.

It should be noted that, in the present embodiment, the second transistor T32 and the third transistor T33 can be alternately turned on to transmit the first low potential signal VS SG as a portion of the scan signal Gate(N), so that the effect of electric stress on the single transistor in an ON state or an OFF state for a long time can be improved, and the operation stability of the second transistor T32 and the third transistor T33 is improved.

In one embodiment, the gate driving unit 310 further includes a first inversion module connected to both the first node Q(N) and the second node.

It should be noted that, in the present embodiment, when the potential of the first node Q(N) is a high potential, the potential of the second node is a low potential; and when the potential of the first node Q(N) is a low potential, the potential of the second node is a high potential.

In one embodiment, the first inversion module includes a transistor T51, a transistor T52, a transistor T53, and a transistor T54. One of a source/drain of the transistor T51 is connected to both one of a source/drain of the transistor T53 and the first control line, another one of the source/drain of the transistor T51 is connected to both a gate of the transistor T53 and one of a source/drain of the transistor T52, another one of the source/drain of the transistor T53 is connected to the second node, a gate of the second transistor T32, and one of a source/drain of the transistor T54, the second low potential line is connected to both another one of the source/drain of the transistor T52 and another one of the source/drain of the transistor T54, and the first node Q(N) is connected to both the gate of the transistor T52 and a gate of the transistor T54.

The first control line is configured to transfer a first control signal which is a low frequency control signal. The second low potential line is configured to transfer a second low potential signal VSSQ.

In one embodiment, the gate driving unit 310 further includes a transistor T11, where one of a source/drain of the transistor T11 is connected to the second control line, a gate of the transistor T11 is connected to a third control line, and another one of the source/drain of the transistor T11 is connected to the first node Q(N).

It should be noted that the second control line is configured to transfer a second control signal, which may be the (N−6)-th stage of scan signal Gate(N−6). The third control line is configured to transfer a third control signal, which may be the (N−6)-th stage of cascade signal ST(N−6).

In one embodiment, the gate driving unit 310 further includes a transistor T22, where one of a source/drain of the transistor T22 is connected to the clock line 200, a gate of the transistor T22 is connected to the first node Q(N), and another one of the source/drain of the transistor T22 is connected to the cascade line.

It should be noted that the cascade line is configured to transfer a cascade signal ST(N).

In one embodiment, the gate driving unit 310 further includes a transistor T72, where one of a source/drain of the transistor T72 is connected to both the another one of the source/drain of the transistor T22 and a cascade line, another one of the source/drain of the transistor T72 is connected to the second low potential line, and a gate of the transistor T72 is connected to the second node.

In one embodiment, the gate driving unit 310 further includes a transistor T42, where one of a source/drain of the transistor T42 is connected to the scan line, another one of the source/drain of the transistor T42 is connected to the second low potential line, and a gate of the transistor T42 is connected to the second node.

In one embodiment, the gate driving unit 310 further includes a capacitor C, where one terminal of the capacitor C is connected to the first node Q(N), and the other terminal of the capacitor C is connected to the scan line.

In one embodiment, the gate driving unit 310 further includes a second inversion module connected to the first node Q(N) and the third node.

It should be noted that, in the present embodiment, when the potential of the first node Q(N) is a high potential, the potential of the third node is a low potential; and when the potential of the first node Q(N) is low, the potential of the third node is a high potential.

In one embodiment, the second inversion module includes a transistor T61, a transistor T62, a transistor T63, and a transistor T64. One of a source/drain of the transistor T61 is connected to both one of a source/drain of the transistor T63 and a fourth control line, another one of the source/drain of the transistor T61 is connected to both a gate of the transistor T63 and one of a source/drain of the transistor T62, another one of the source/drain of the transistor T63 is connected to the third node, the gate of the third transistor T33, and one of a source/drain of the transistor T64, the second low potential line is connected to both another one of the source/drain of the transistor T62 and another one of the source/drain of the transistor T64, and the first node Q(N) is connected to both the gate of the transistor T62 and a gate of the transistor T64.

The fourth control line is configured to transfer a fourth control signal which is a low frequency control signal. When the first control signal is a low potential, the fourth control signal is a high potential; and when the first control signal is a high potential, the fourth control signal is a low potential.

In an embodiment, the gate driving unit 310 further includes a transistor T43, where one of a source/drain of the transistor T43 is connected to the scan line, another one of the source/drain of the transistor T43 is connected to the second low potential line, and a gate of the transistor T43 is connected to the third node.

In an embodiment, the gate driving unit 310 further includes a transistor T73, where one of a source/drain of the transistor T73 is connected to the scan line, another one of the source/drain of the transistor T73 is connected to the second low potential line, and a gate of the transistor T73 is connected to the third node.

In an embodiment, the gate driving unit 310 further includes a transistor T41, where one of a source/drain of the transistor T41 is connected to the first node Q(N), another one of the source/drain of the transistor T41 is connected to the second low potential line, and a gate of the transistor T41 is connected to a fifth control line.

The fifth control line is configured to transfer a fifth control signal, which may be a (N+8)-th stage of scan signal Gate(N+8).

FIG. 3 is a timing diagram of the gate driving unit 310 shown in FIG. 2. A waveform of the (N−6)-th stage of scan signal Gate(N−6), that is, G(N−6), is the same as that of the (N−6)-th stage of cascade signal ST(N−6). When the scan signal Gate(N−6) and the cascade signal ST(N−6) both are at a low potential, the transistor T11 is in an OFF state. At this time, the potential of the first node Q(N) is a low potential, and one of the second node or the third node is at a high potential, so that one of the second transistor T32/the third transistor T33 is in an on state. At this time, the first low potential signal VSSG is used as a portion of the scan signal Gate(N), that is, G(N).

When both the (N−6)-th stage of scan signal Gate(N−6), that is G(N−6), and the (N−6)-th cascade signal ST(N−6) are switched to a high potential, the potential of the first node Q(N) starts to rise, and the first transistor T21 is turned on. At this time, the clock signal CK(N) is used as a portion of the scan signal Gate(N).

When the (N+8)-th stage of scan signal Gate(N+8) is switched to a high potential, the transistor T41 pulls down the potential of the first node Q(N) to a low potential. At this time, one of the second node or the third node is at a high potential, and one of the second transistor T32/the third transistor T33 is in an ON state. At this time, the first low potential signal VSSG is used as a portion of the scan signal Gate(N), that is, G(N).

Therefore, the scan signal Gate(N) may be composed of a combination of the clock signal CK(N) and the first low potential signal VSSG. For example, the potentials of the scan signal Gate(N) in time are the third potential V3 of the first low potential signal VSSG, the first potential V1 of the clock signal CK(N), the second potential V2 of the clock signal CK(N), the first potential V1 of the clock signal CK(N), and the third potential V3 of the first low potential signal VSSG in sequence.

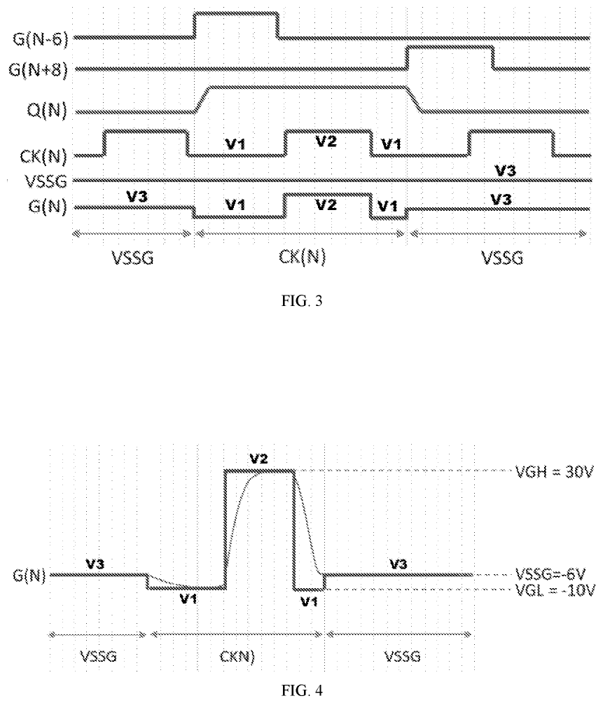

FIG. 4 is a waveform diagram of the scan signal Gate(N) in the related art shown in FIG. 3. The first potential V1, i.e., VGL, of the clock signal CK(N) may be −10V, and the second potential V2, i.e., VGH, of the clock signal CK(N) may be 30V. The third potential V3 of the first low potential signal VSSG may be −6V. In this state, since the voltage difference between the first potential V1 and the second potential V2 of the clock signal CK(N) is relatively small, the actual falling edge of the scan signal Gate(N) is relatively gradual, and is much different from the vertical falling edge in the ideal state.

FIG. 5 is a charging schematic diagram of an ideal state according to an embodiment of the present application. The rising edge and the falling edge of both the scan signal Gate(N) and the data signal Data are both vertical, and the pulse of the scan signal Gate(N) can be completely overlaid to the pulse of the data signal Data, so that the maximum charging time in the ideal state can be reached.

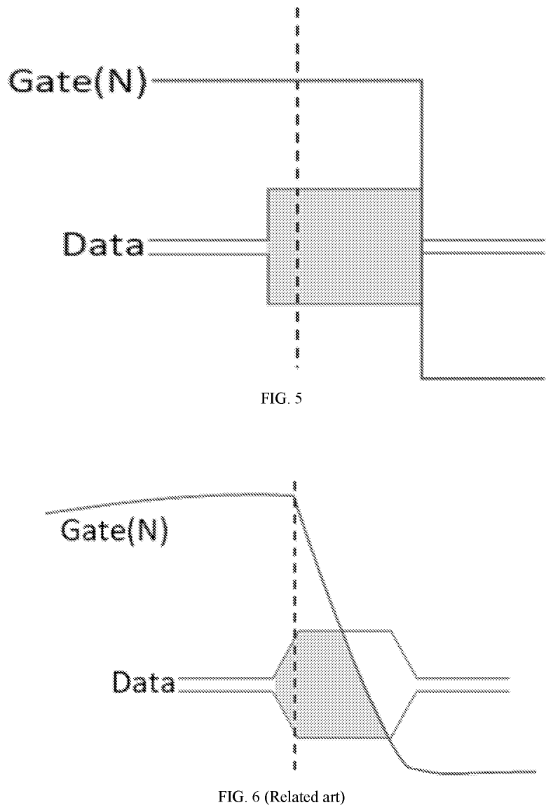

FIG. 6 is a charging schematic diagram of the related art. Neither the waveform of the scan signal Gate(N) nor the waveform of the data signal Data is satisfactory, so that the charging can be only performed effectively for a shaded portion, and cannot be realized within a time corresponding to the blank portion on the right side, thereby reducing the charging time.

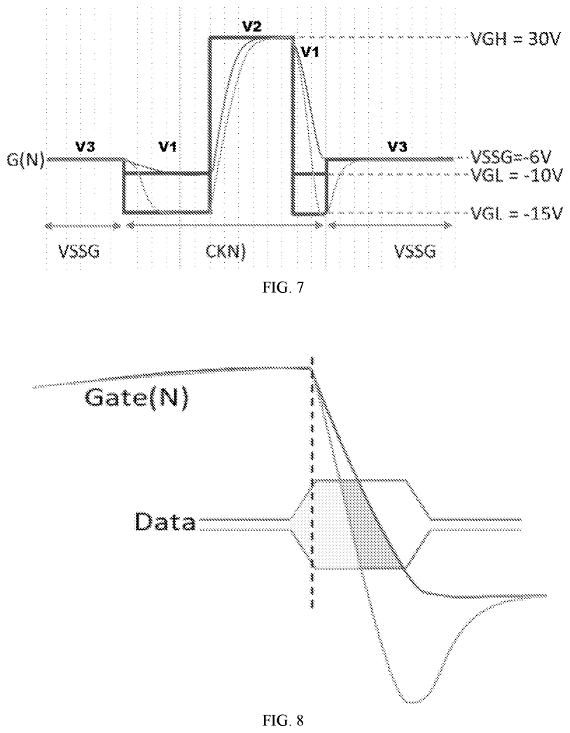

FIG. 7 is a waveform diagram of the scan signal Gate(N) according to an embodiment of the present application. The first potential V1 of the clock signal CK(N) and/or the second potential V2 of the clock signal CK(N) are changed to increase the voltage difference between the first potential and the second potential of the clock signal CK(N). For example, the second potential V2 of the clock signal CK(N) may be maintained unchanged and the first potential V1 of the clock signal CK(N) may be decreased. As such, the verticality of the falling edge of the scan signal Gate(N) may be improved. For example, when the second potential V2, i.e., VGH, of the clock signal CK(N) maintains unchanged and the first potential V1, i.e., VGL, of the clock signal CK(N) is decreased from −10V to −15V, it can be seen that the falling edge of the clock signal CK(N) also approximates the ideal state.

FIG. 8 is a charging diagram under the control of the scan signal Gate(N) shown in FIG. 7. Since the falling edge of the scan signal Gate(N) becomes sharper, the pulse of the scan signal Gate(N) can be overlaid to less pulses of the data signal Data, resulting in reduction in the charging time.

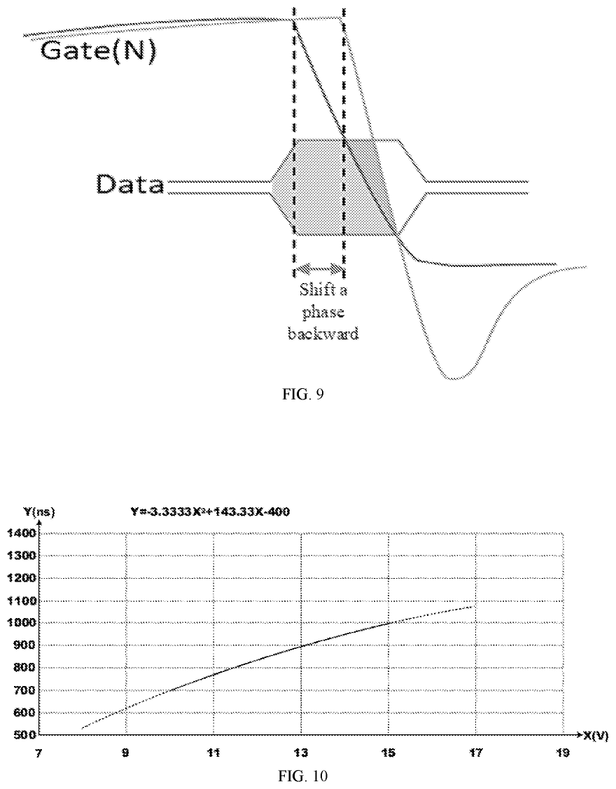

FIG. 9 is a charging diagram under the condition that a phase of the clock signal CK(N) is shifted backward on the basis of FIG. 8. After the phase of the clock signal CK(N) is shifted backward, the pulse of the scan signal Gate(N) can be overlaid to more pulses of the data signal Data, which increases the charging time, that is, increases the writing time of the data signal Data.

It should be noted that the larger the voltage difference between the first potential and the second potential V2 of the clock signal CK(N) is, the more vertical the falling edge of the scan signal Gate(N) will become. Accordingly, it is necessary to increase the amount of phase change of the clock signal CK(N) so as to increase an overlapping time between the pulse of the scan signal Gate(N) and the pulse of the data signal Data in timing. That is, the voltage difference is in a positive relationship with the amount of phase change of the clock signal CK(N), so that the charging time can be maximized.

In another embodiment, the phase of the scan signal Gate(N) may be directly shifted backward by the gate driving circuit 300 while the phase of the clock signal CK(N) maintains unchanged. For example, a phase adjustment module or a phase shift module for shifting the phase backward may be added to each gate driving unit 310 of the gate driving circuit 300, so as to shift the phase of the scan signal Gate(N) backward.

It should be noted that an end time of the effective charging time is earlier than or equal to a start time of an end edge of the data signal, and the end edge is a falling edge of a positive pulse or a rising edge of a negative pulse. The end time of the effective charging time may be a time when the potential of the scan signal Gate(N) falls below a potential that is insufficient to maintain an ON state of the thin film transistor in the pixel in which the pulse amplitude of the data signal Data is allowed to pass through the thin film transistor without loss. Alternatively, at and before the start time of the end edge, the scan signal Gate(N) controls the thin film transistor in the pixel to be in the ON state to write the pulse amplitude of the data signal Data to the pixel. In this way, the effective charging time can be maximized to improve a case where the charging time is insufficient.

FIG. 10 is a schematic diagram of the relationship between the effective charging time and the absolute value of the first potential V1 according to an embodiment of the present application. The abscissa X represents the absolute value of the first potential V1, i.e., VGL, of the clock signal CK(N) in volts (V). The ordinate Y represents the effective charging time in nanoseconds (ns). The relationship between the two satisfies: Y=−3.3333X2+143.33X-400 ns.

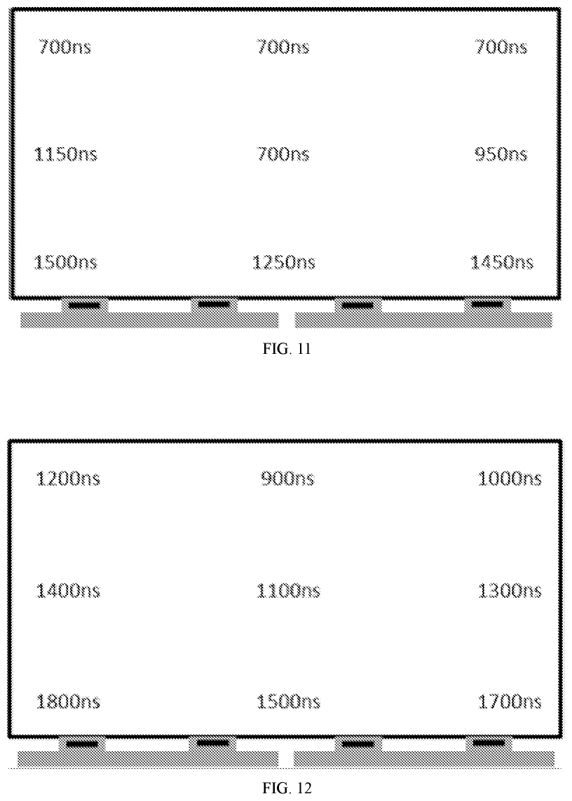

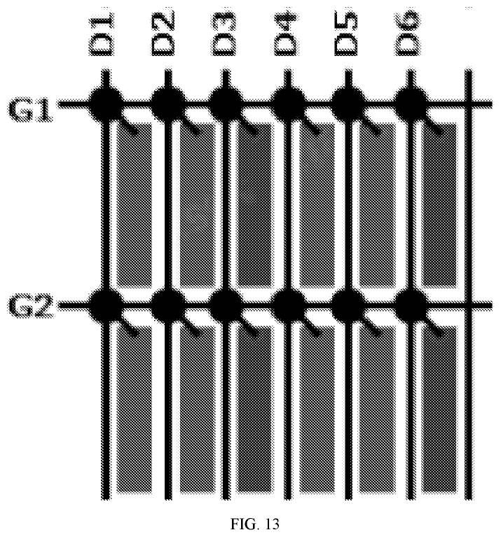

FIG. 11 is a schematic diagram of a charging time distribution based on the charging effect shown in FIG. 6, and FIG. 12 is a schematic diagram of a charging time distribution based on the charging effect shown in FIG. 9. In comparison with FIG. 11, in the case where the clock signal CK(N) is shifted backward in phase and the falling edge thereof is adjusted more vertically, the charging time of the display panel at the same position is correspondingly increased as shown in FIG. 12. For example, in the display panel, the charging time of the pixel in the upper left portion is increased from 700 ns to 1200 ns, the charging time of the pixel in the middle left portion is increased from 1150 ns to 1400 ns, and the charging time of the pixel in the lower left portion is increased from 1500 ns to 1800 ns. The charging time of the pixel in the upper middle portion is increased from 700 ns to 900 ns, the charging time of the pixel in the right center portion is increased from 700 ns to 1100 ns, and the charging time of the pixel in the lower middle portion is increased from 1250 ns to 1500 ns. The charging time of the pixel in the upper right portion is increased from 700 ns to 1000 ns, the charging time of the pixel in the middle right portion is increased from 950 ns to 1300 ns, and the charging time of the pixel in the lower right portion is increased from 1450 ns to 1700 ns.

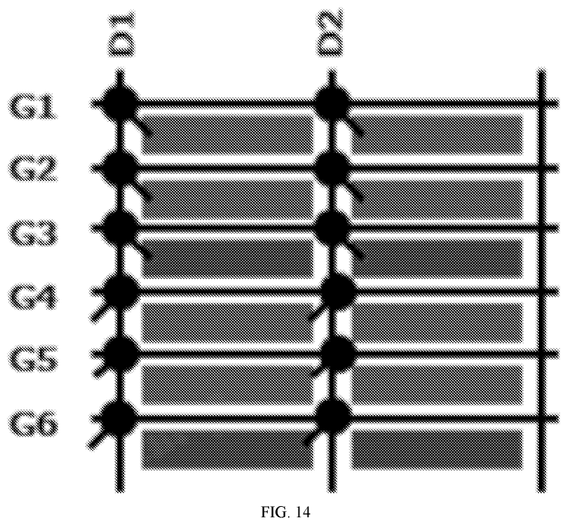

It should be noted that the method for increasing a charging time provided in the present application can be applied to various types of display panels, for example, a liquid crystal display panel or a self-luminous display panel. It is also possible to apply the method to various pixel driving architectures, such as a pixel driving architecture shown in FIG. 13, i.e., 1G1D, in which a row of pixels are driven by a scan line, and a data line provides a data signal Data for a column of pixels; or for example, a three-dimensional transistor (i.e., Tri-gate) pixel driving architecture shown in FIG. 14.

The display device may include a display panel including a plurality of pixels arranged in an array, where each of the pixels includes a thin film transistor, and where a gate of the thin film transistor is connected to the scan signal Gate(N), and one of a source/drain of the thin film transistor is connected to the data signal Data, so that the scan signal Gate(N) may control an effective charging time of the data signal Data.

Another embodiment of the present application provides a display charging method, including: outputting, by a gate driving circuit 300, a scan signal Gate(N) according to a received clock signal CK(N), where the clock signal CK(N) has a first potential V1 and a second potential V2 that are alternately continuous, the first potential V1 being less than the second potential V2; configuring the scan signal Gate(N) to have a portion of the clock signal CK(N), where the scan signal Gate(N) is changed in the order of the first potential V1, the second potential V2, and the first potential V1 within a first predetermined time period; and increasing, by a display device, a voltage difference between the first potential V1 and the second potential V2 of the scan signal Gate(N), and adjusting a phase of the scan signal Gate(N) to increase an effective charging time of a pixel corresponding to the scan signal Gate(N).

It should be understood that, according to the display charging method provided in the embodiment of the present application, by increasing the voltage difference between the first potential and the second potential of the scan signal Gate(N), the falling edge of the scan signal Gate(N) can approximate the vertical falling edge in the ideal state, and by adjusting the phase of the scan signal Gate(N) in a timing at the same time, the pulse duration of the scan signal Gate(N) can be overlaid to the pulse duration of more data signals Data, so that the effective charging time of the data signals Data can be increased.

In the foregoing embodiments, descriptions of the embodiments are emphasized. A portion that is not described in detail in an embodiment may refer to related descriptions in another embodiment.

The display device and the display charging method provided in the embodiments of the present application are described in detail above. In this specification, principles and implementations of the present application are illustrated by applying specific examples herein. The description of the above embodiments is only configured to help understand the technical solutions and core ideas of the present application; those of ordinary skill in the art should understand that it is still possible to modify the technical solutions recorded in the foregoing embodiments, and these modifications or replacements do not cause the essence of the corresponding technical solutions to deviate from the scope of the technical solutions of the embodiments of the present application.

What is claimed is:

1. A display device, comprising:
a timing controller for transmitting a clock signal, wherein the clock signal has a first potential and a second potential that are alternately continuous, the first potential being less than the second potential; and
a gate driving circuit for outputting a scan signal based on the received clock signal, wherein the scan signal has a portion of the clock signal and is changed in the order of the first potential, the second potential, and the first potential within a first predetermined time period;
wherein the display device increases a voltage difference between the first potential and the second potential of the scan signal, and adjusts a phase of the scan signal to increase an effective charging time of a pixel corresponding to the scan signal.

2. The display device of claim 1, wherein, the timing controller changes the first potential of the clock signal and/or the second potential of the clock signal to increase the voltage difference between the first potential and the second potential of the clock signal.

3. The display device of claim 2, wherein, the timing controller maintains the second potential of the clock signal unchanged and reduces the first potential of the clock signal.

4. The display device of claim 1, wherein, the voltage difference in the display device is configured to be in a positive relationship with the amount of phase change of the clock signal.

5. The display device of claim 1, wherein, the timing controller shifts a phase of the clock signal backward and/or the phase of the gate driving circuit shifts a phase of the scan signal backward.

6. The display device of claim 1, wherein, the scan signal is configured to control an effective charging time of the data signal, wherein an end time of the effective charging time is earlier than or equal to a start time of an end edge of the data signal, and the end edge is a falling edge of a positive pulse or a rising edge of a negative pulse.

7. The display device of claim 6, wherein, at and before the start time of the end edge, the scan signal controls a thin film transistor in the pixel to be in an ON state to write a pulse amplitude of the data signal to the pixel.

8. The display device of claim 1, wherein, the display device further comprises a first low potential line for transferring a first low potential signal; and
wherein the scan signal further has a portion of the first low potential signal before and after a first preset time period, respectively.

9. The display device of claim 8, wherein, the first low potential signal has a third potential greater than the first potential and less than the second potential; and
the scan signal has the third potential in a second preset time period, wherein the second preset time period and the first preset time period are alternately continuous in time.

10. The display device of claim 2, wherein, the timing controller maintains the first potential of the clock signal unchanged and increases the second potential of the clock signal.

11. The display device of claim 2, wherein, the timing controller reduces the first potential of the clock signal and increases the second potential of the clock signal.

12. The display device of claim 1, wherein, the gate driving circuit comprises a plurality of cascaded gate driving units, and each of the plurality cascaded gate driving units comprises a first transistor, wherein one of a source/drain of the first transistor is connected to a clock line, a gate of the first transistor is connected to a first node, and another one of the source/drain of the first transistor is connected to a scan line; wherein, the scan line is configured to transfer the scan signal.

13. The display device of claim 12, wherein, each of the plurality cascaded gate driving units further comprises a second transistor, wherein one of a source/drain of the second transistor is connected to both the another one of the source/drain of the first transistor and the scan line, another one of the source/drain of the second transistor is connected to a first low potential line, and a gate of the second transistor T32 is connected to a second node.

14. The display device of claim 13, wherein, each of the plurality cascaded gate driving units further comprises a third transistor, wherein one of a source/drain of the third transistor is connected to all of the another one of the source/drain of the first transistor, the scan line, and the one of the source/drain of the second transistor, another one of the source/drain of the third transistor is connected to the first low potential line, and a gate of the third transistor is connected to a third node, and wherein, the third transistor and the second transistor are turned on in a timing division manner.

15. The display device of claim 14, wherein, each of the plurality cascaded gate driving units further comprises a first inversion module connected to both the first node and the second node.

16. The display device of claim 15, wherein, each of the plurality cascaded gate driving units further comprises a capacitor, wherein one terminal of the capacitor is connected to the first node, and the other terminal of the capacitor is connected to the scan line.

17. The display device of claim 16, wherein, each of the plurality cascaded gate driving units further comprises a second inversion module connected to the first node and the third node.

18. The display device of claim 1, further comprising a plurality of pixels arranged in an array, wherein each of the pixels comprises a thin film transistor, wherein a gate of the thin film transistor is connected to the scan signal, and one of a source/drain of the thin film transistor is connected to data signal.

19. A display charging method, comprising:
outputting, by a gate driving circuit, a scan signal based on a received clock signal, wherein the clock signal has a first potential and a second potential that are alternately continuous, the first potential being less than the second potential;
configuring the scan signal to have a portion of the clock signal, wherein the scan signal is changed in the order of the first potential, the second potential, and the first potential within a first predetermined time period; and
increasing, by a display device, a voltage difference between the first potential and the second potential of the scan signal, and adjusting a phase of the scan signal to increase an effective charging time of a pixel corresponding to the scan signal.
